(19) United States
(12) Patent Application Publication
(10) Pub. No.: US 2015/0116918 A1
(43) Pub. Date: Apr. 30, 2015

(54) DUST-RESISTANT KEYBOARD ASSEMBLY

(71) Applicants: Fu Tai Hua Industry (Shenzhen) Co., Ltd., Shenzhen (CN); HON HAI PRECISION INDUSTRY CO., LTD., New Taipei (TW)

(72) Inventor: JIAN-GUO WU, Shenzhen (CN)

(21) Appl. No.: 14/497,855

(22) Filed: Sep. 26, 2014

(30) Foreign Application Priority Data
Oct. 28, 2013 (CN) 2013105144118

(51) Int. Cl. G06F 1/18

(52) U.S. Cl. CPC G06F 1/182
USPC 361/679.08

(57) ABSTRACT

A dust-resistant keyboard assembly includes a keyboard body and a dust-resistant cover. The dust-resistant cover connects to the keyboard body and is moveable from a first state where the dust-resistant cover is positioned above the keyboard body to a second state where the dust-resistant cover abuts the keyboard body.

### FIELD

The present disclosure relates to keyboards, especially relates to a dust-resistant keyboard assembly.

### BACKGROUND

Keyboards are exposed to the air, thus dust drops on the keyboards. Generally, protective coatings are attached to the keyboards to prevent dust from contaminating the keyboards.

### BRIEF DESCRIPTION OF THE DRAWING

The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is an isometric view of a dust-resistant keyboard assembly, with a shield plate covering a keyboard body.

FIG. 2 is an isometric view of the dust-resistant keyboard assembly of FIG. 1, with the shield plate rotating 90 degrees around the keyboard body.

FIG. 3 is an exploded isometric view of the dust-resistant keyboard assembly of FIG. 2.

FIG. 4 is an isometric view of the dust-resistant keyboard assembly of FIG. 1, with the shield plate rotating 180 degrees around the keyboard body.

FIG. 5 is an isometric view of the dust-resistant keyboard assembly of FIG. 4, with the keyboard body positioned above the shield plate.

### DETAILED DESCRIPTION

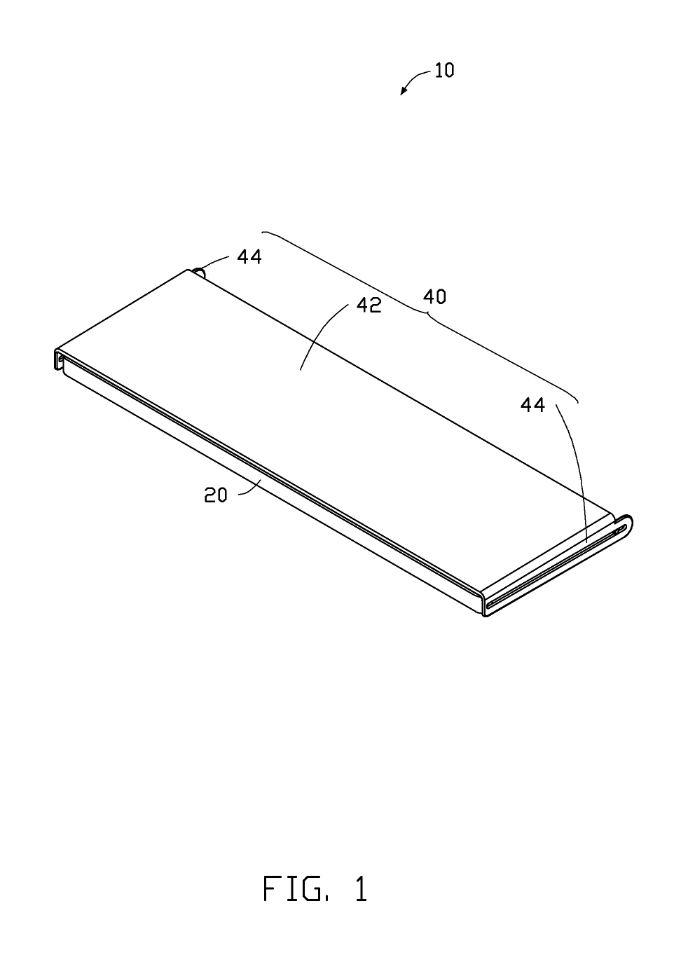

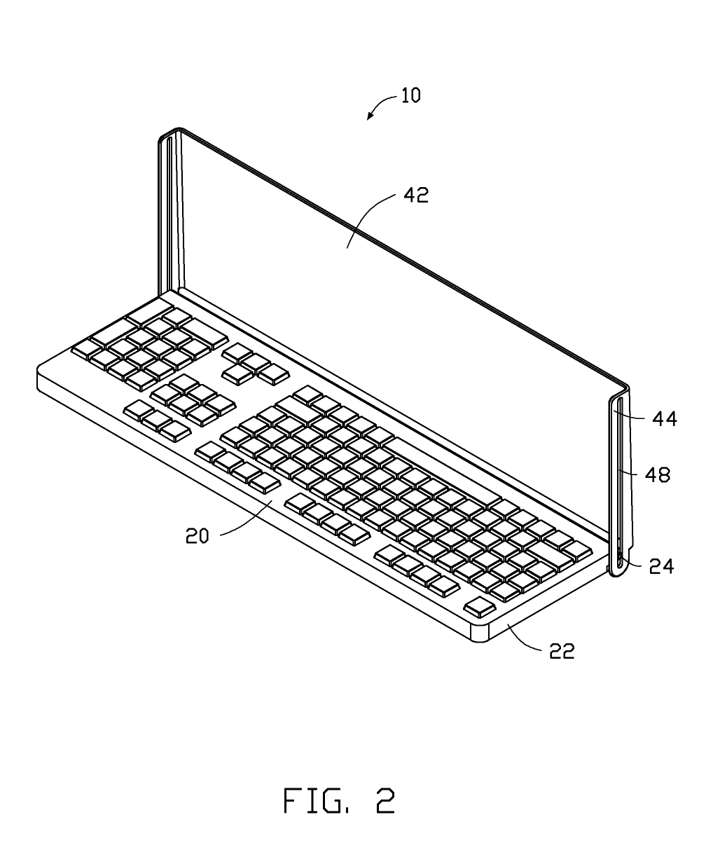

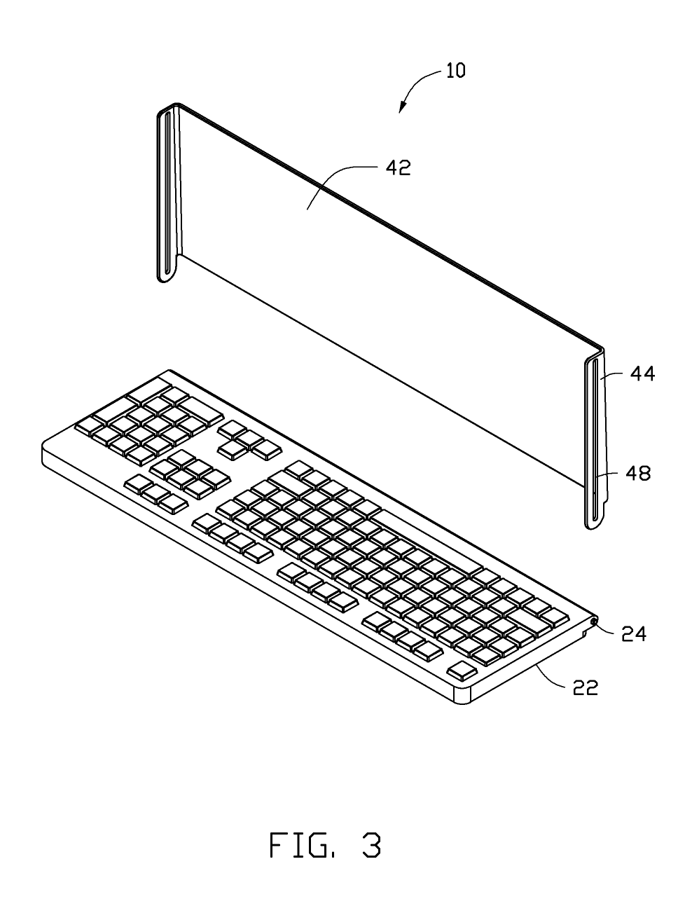

FIG. 1 illustrates a dust-resistant keyboard assembly 10 of an embodiment. The dust-resistant keyboard assembly 10 includes a keyboard body 20 and a dust-resistant cover 40. FIGS. 2 and 3 illustrate the dust-resistant keyboard assembly 10 further includes two rotation shafts 24. The two rotation shafts 24 are respectively fixed to two lateral sides 22 of the keyboard body 20 and are positioned on an end of the keyboard body 20. The dust-resistant cover 40 includes a shield plate 42 and two sidewalls 44 respectively extending from two opposite ends of the shield plate 42 toward a same direction. Each sidewall 44 defines a guide groove 48. A size of the shield plate 42 corresponds to that of the keyboard body 20. The shield plate 42 is configured to cover the keyboard body 20 to prevent dust from contaminating the keyboard body 20.

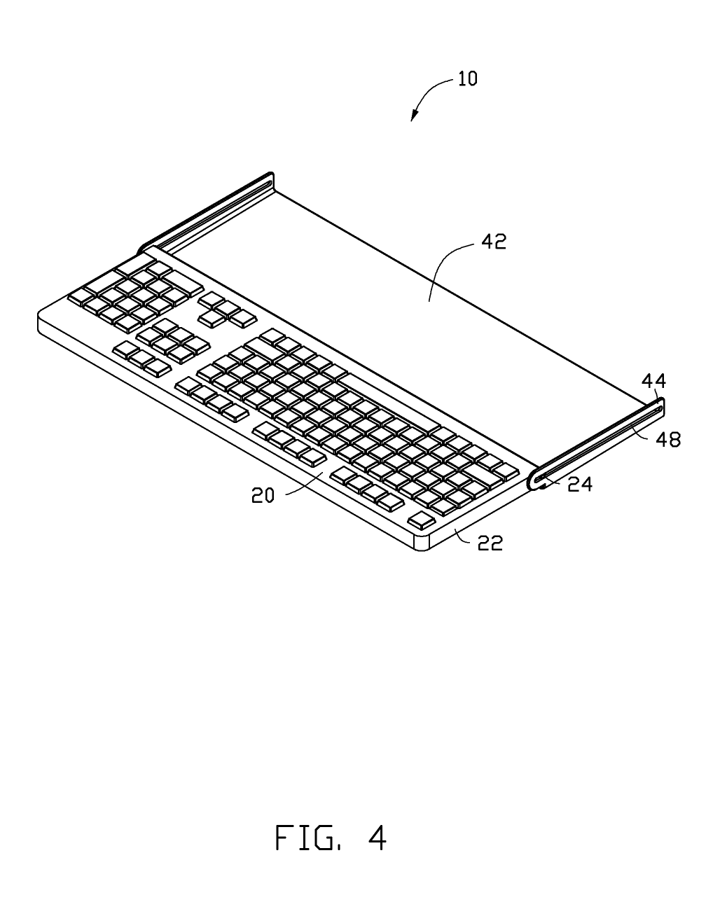

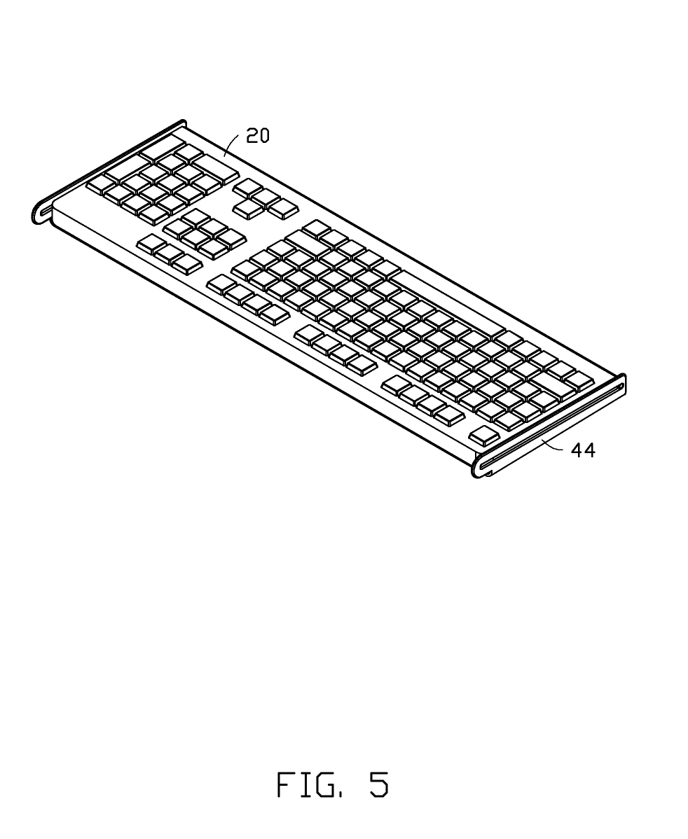

FIG. 4 illustrates that the two sidewalls 44 are respectively sleeved on the two rotation shafts 24 via the two guide grooves 48. The dust-resistant cover 40 rotates 180 degrees around the rotation shafts 24 from a first state, where the shield plate 42 covers the keyboard body 20 to cover a number of keys on the keyboard body 20, to a second state where the shield plate 42 abuts the keyboard body 20 so that the number of the keys on the keyboard body 20 are exposed. When the shield plate 42 abuts with the keyboard body 20, the two rotation shafts 24 respectively slide along the two slide grooves 46 toward the shield plate 42 to position the keyboard body 20 above the shield plate 42. FIG. 5 illustrates an isometric view of the dust-resistant keyboard assembly 10 with the keyboard body 20 positioned above the shield plate 42.

The length of the guide groove 48 along the sidewall 44 is equal to that of the lateral side 22. Thus, the rotation shaft 24 slides along an end of the slide grooves 46 toward the shield plate 42, the keyboard body 20 is positioned above the shield plate 42. An end of the sidewall 44 defines a rounded corner for a clean appearance.

In at least one embodiment, a thickness of the shield plate 42 is tapered. In this way, when the keyboard body 20 is positioned above the shield plate 42, the keyboard body 20 is tapered for convenient use.

In at least one embodiment, the rotation shaft 24 defines a screw thread at a distal end of the rotation shaft 24. When the dust-resistant cover 40 is sleeved on the rotation shaft 24, two screws (not shown) are screwed with the distal end of the rotation shaft 24 to prevent the dust-resistant cover 40 from dislodging from the keyboard 20.

It is understood that the present disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A dust-resistant keyboard assembly comprising:
a keyboard body; and
a dust-resistant cover connected to the keyboard body and moveable from a first state where the dust-resistant cover being positioned above the keyboard body to a second state where the dust-resistant cover abutting the keyboard body.

2. The dust-resistant keyboard assembly as claimed in claim 1, wherein the dust-resistant cover is rotationally connected to the keyboard body.

3. The dust-resistant keyboard assembly as claimed in claim 2, wherein the keyboard body comprises two rotation shafts, the two rotation shafts are respectively fixed to two lateral sides of the keyboard body, the dust-resistant cover defines two guide grooves, the dust-resistant cover is sleeved on the two rotation shafts by the two guide grooves.

4. The dust-resistant keyboard assembly as claimed in claim 3, wherein the two rotation shafts are positioned on an end of the keyboard body.

5. The dust-resistant keyboard assembly as claimed in claim 3, wherein each rotation shaft defines screw thread at a distal end of the rotation shaft, two screw are screwed with the distal end of the rotation shaft.

6. The dust-resistant keyboard assembly as claimed in claim 3, wherein the dust-resistant cover comprises a shield plate configured to cover the keyboard body and two sidewalls respectively extending from two opposite ends of the shield plate toward a side of the shield plate, each sidewall defines one of the two guide grooves.

7. The dust-resistant keyboard assembly as claimed in claim 6, wherein a sickness of the shield plate is tapered.

8. The dust-resistant keyboard assembly as claimed in claim 6, wherein the two rotation shafts further slide along the two slide grooves toward the shield plate to position the keyboard body above the shield plate when the shield plate abuts the keyboard body.

9. The dust-resistant keyboard assembly as claimed in claim 8, wherein the length of the guide groove along the sidewall is equal to that of the lateral side.

10. The dust-resistant keyboard assembly as claimed in claim 8, wherein an end of the sidewall defines a rounded corner.

11. A dust-resistant keyboard assembly comprising:
a keyboard body; and
a dust-resistant cover connected to the keyboard body and moveable from a first state where the dust-resistant cover being positioned above the keyboard body to a second state where the dust-resistant cover being positioned under the keyboard body.

12. The dust-resistant keyboard assembly as claimed in claim 11, wherein the dust-resistant cover is rotationally connected to the keyboard body.

13. The dust-resistant keyboard assembly as claimed in claim 12, wherein the keyboard body comprises two rotation shafts, the two rotation shafts are respectively fixed to two lateral sides of the keyboard body, the dust-resistant cover defines two guide grooves, the dust-resistant cover is sleeved on the two rotation shafts by the two guide grooves.

14. The dust-resistant keyboard assembly as claimed in claim 13, wherein the dust-resistant cover comprises a shield plate configured to cover the keyboard body and two sidewalls respectively extending from two opposite ends of the shield plate toward a side of the shield plate, each sidewall defines one of the two guide grooves.

15. The dust-resistant keyboard assembly as claimed in claim 14, wherein the two rotation shafts further slide along the two slide grooves toward the shield plate to position the keyboard body above the shield plate when the shield plate rotates to abut the keyboard body.

16. A keyboard assembly comprising:
A keyboard body comprising a plurality of keys; and
a dust-resistant cover coupled to the keyboard body, the dust-resistant cover having a first configuration and a second configuration;
the first configuration of the dust-resistant cover being where the dust-resistant abuts the keyboard body so that the plurality of keys are exposed;
the second configuration of the dust-resistant cover being where the dust-resistant cover is positioned above the keyboard body and covers the plurality of keys.

17. The dust-resistant keyboard assembly as claimed in claim 16, wherein the dust-resistant cover is rotationally connected to the keyboard body.

18. The dust-resistant keyboard assembly as claimed in claim 17, wherein the keyboard body comprises two rotation shafts, the two rotation shafts are respectively fixed to two lateral sides of the keyboard body, the dust-resistant cover defines two guide grooves, the dust-resistant cover is sleeved on the two rotation shafts by the two guide grooves.

19. The dust-resistant keyboard assembly as claimed in claim 18, wherein the dust-resistant cover comprises a shield plate configured to cover the keyboard body and two sidewalls respectively extending from two opposite ends of the shield plate toward a side of the shield plate, each sidewall defines one of the two guide grooves.

20. The dust-resistant keyboard assembly as claimed in claim 19, wherein the two rotation shafts further slide along the two slide grooves toward the shield plate to position the keyboard body above the shield plate when the shield plate abuts the keyboard body.
